(19) United States
(12) Patent Application Publication
(10) Pub. No.: US 2006/0053429 A1
(43) Pub. Date: Mar. 9, 2006

(54) OPTICAL DISC RECORDING DEVICE

(76) Inventors: Chih-Chung Hsieh, Hsinchu (TW); Jeng-Jiun Chen, Hsinchu (TW); Bor-Ruey Chen, Hsinchu (TW); Hui-Chung Leu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,649

(22) Filed: Apr. 11, 2005

(30) Foreign Application Priority Data
Sep. 8, 2004 (TW) 93127121

(51) Int. Cl. G11B 7/24; G11B 33/14

(52) U.S. Cl. 720/648

(57) ABSTRACT

An optical disc recording device including a housing, an optical read/write module and a transmission module. Both the optical read/write module and the transmission module are disposed inside the housing. Besides, the housing includes a bottom housing and a top cover. The inner surface of top cover has a first protrusion and a second protrusion, which together can stabilize the flow-field in the optical disc recording device so that the optical disc can rotate stably.

### CROSS-REFERENCE TO RELATED APPLICATION

This application claims the priority benefit of Taiwan application serial no. 93127121, filed on Sep. 8, 2004.

### BACKGROUND OF THE INVENTION

1. Field of Invention

The present invention relates to an optical disc recording device. More particularly, the present invention relates to an optical disc recording device capable of stabilizing inner flow field.

2. Description of Related Art

The optical discs have such advantages as large storage capacity, easy preservation, long preservation period, low cost, and so on. Consequently, the optical discs now have gradually replaced traditional magnetic storing medium as one of indispensable optical storing media for modern people. Generally speaking, users could access the data recorded on the optical discs by using read-only memory (CD-ROM), which however, is unable to record the data on the optical discs. Thus, the CD recording device having both reading and recording functions has become the mainstream in the market.

FIG. 1A schematically illustrates a diagram of a conventional decomposed 32× optical disc recording device. Please refer to FIG. 1A. The conventional optical disc recording device 100 mainly comprises a housing 110, an optical write/read module 120, a transmission module 130, and a front plate 160. The housing 110 comprises a bottom housing 112 and a top cover 150. The optical write/read module 120 and the transmission module 130 are disposed inside the housing respectively. Besides, the front plate 160 is connected to the top cover 150 and the bottom housing 112 and usually the front plate 160 has an insertion/rejection opening 162 to load or unload the optical disc. In addition, in the conventional optical disc recording device, manufacturers often stamp the grooves 154a and 154b on the outer surface 154 of the top cover 150 to have better structure intensity.

In general, the writing-mode of the optical disc recording device 100 can be classified as Constant Linear Velocity Mode (CLV Mode), Constant Angular Velocity Mode (CAV Mode), Zone-Constant Linear Velocity Mode (Z-CLV Mode), Partial-Constant Angular Velocity Mode (P-CAV Mode), etc. Among the high-speed recording devices, the Z-CLV Mode is most widely used.

Take a 32×, Z-CLV Mode recording device for example. The data are usually recorded at 16× speed, 24× speed (in location about the 110th minute on discs) and at 32× speed (in location about the 30th minute on discs) on different sections of the disc. When the optical disc recording device 100 is writing data on the disc at 32× speed in location about 44th to 48th minute (at a rotation speed about 7600 rounds per minute), due to the unstable flow field in the optical disc recording device caused by the high-speed rotation of the optical disc, and the coupling effect between the unstable flow field and the optical disc, the optical disc would thus flutter or deform, which not only lowers the writing quality but also results in failure in writing/accessing data in location about the 44th to the 48th minute.

FIG. 1B shows measured results of the error rate C1 of decoding output of the RS-code in the first layer and the error rate C2 of decoding output of the RS-code in the second layer during a recording operation of a conventional 32× speed, Z-CLV Mode optical disc recording device. As shown in FIG. 1B, apparently both the error rate C1 of decoding output of the RS-code in the first layer and the error rate C2 of decoding output of the RS-code in the second layer have one peak value.

However, if the error rate C1 of decoding output of the RS-code in the first layer and the error rate C2 of decoding output of the RS-code in the second layer are too high, it means the writing quality deteriorates, which results in failing in writing/accessing data in the location about 44th to 48th minutes. So it's concluded that the lower error rate C1 of decoding output of the RS-code in the first layer and the lower error rate C2 of decoding output of the RS-code in the second layer, the better writing quality of the optical disc.

### SUMMARY OF THE INVENTION

Accordingly, the present invention provides an optical disc recording device capable of stabilizing the inner flow field of the optical disc recording device and effectively increasing the writing quality.

The invention provides an optical disc recording device comprising a housing, an optical read/write module and a transmission module. The housing comprises a bottom housing and a top cover. Both of the optical read/write module and the transmission module are disposed inside the housing. Subsequently, the optical write/read module comprises an optical write/read head, which moves back and forth along a track-seeking path, and the transmission module is suitable for rotating an optical disk with respect to a rotation axis. It should be noted that, the top cover has an inner surface and an outer surface, and the inner surface of the top cover has a first protrusion and a second protrusion both disposed above the track-seeking path. The first protrusion is closer to the rotation axis than the second protrusion, and the height of the first protrusion is lower than that of the second protrusion.

In the present embodiment, the optical write/read head further comprises a fixed base, a pair of lead rods, and a first driving motor. The fixed base is disposed inside the housing and the pair of lead rods are disposed over the fixed base. Besides, the optical write/read head is disposed on the pair of lead rods to move back and forth along the track-seeking path, and the first driving motor drives the optical write/read head to move back and forth along the track-seeking path.

In the present embodiment, the transmission module comprises a second driving motor, a lower clamping piece, and an upper clamping piece. The second driving motor is disposed inside the housing, and the lower clamping piece is connected to the second driving motor. Besides, the upper clamping piece is disposed above the lower clamping piece, and the lower clamping piece together with the upper clamping piece are adapted for clamping the optical disc. Further, the lower clamping piece together with the upper clamping piece, for example, clamp the disc magnetically.

In the present embodiment, the outer surface of the top cover, for example, further has at least one structure-strengthening groove.

In the present embodiment, the first protrusion, for example, is one straight protrusion and its extended direction is perpendicular to the track-seeking path. Besides, the first protrusion is disposed in an area 30 to 40 mm away from the rotation axis with a height range of about 0.8 to 1.2 mm.

In the present embodiment, the second protrusion, for example, is one straight protrusion, which extends in a direction perpendicular to the track-seeking path. The second protrusion is disposed in an area 45 to 55 mm away from the rotation axis with a height range of about 1.6 to 2.4 mm.

The optical disc recording device according one embodiment of the present invention, for example, further comprises a front plate connected to the bottom housing and the top cover, and the front plate usually has an insertion/rejection opening for loading or unloading the optical disc.

Based on the description above, in the present invention, a first protrusion and a second protrusion are disposed in proper locations on the top cover of the optical disc recording device such that the inner flow field of the optical disc recording device can be stabilized and the writing quality using the optical discs recording device can be enhanced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A schematically illustrates an exploded diagram of a conventional 32× speed optical disc recording device.

FIG. 1B shows measured results of the error rate C1 of decoding output of the RS code in the first layer and the error rate C2 of decoding output of the RS code in the second layer during a recording operation in a conventional 32× speed, Z-CLV Mode optical disc recording device.

FIG. 2A shows a schematic and exploded diagram of an optical disc recording device according to an embodiment of the invention.

FIG. 2B schematically illustrates the structure of an optical write/read module and a transmission module of the optical disc recording device according to an embodiment of the invention.

FIG. 3A schematically illustrates a top view of the top cover of an optical disc recording device according to an embodiment of the invention.

FIG. 3B schematically illustrates s side view of the top cover of an optical disc recording device according to an embodiment of the invention.

FIG. 4A illustrates a relationship chart between the writing speed versus location of the optical disc in the Z-CLV Mode optical disc recording device.

FIG. 4B schematically illustrates a relationship chart between the rotation speed (RPM) versus location of the optical disc in the Z-CLV Mode optical disc recording device.

FIG. 5 is a measured result of the error rate C1 of decoding output of the RS-code in the first layer and the error rate C2 of decoding output of the RS-code in the second layer during a decoding operation in the 32× speed, Z-CLV Mode optical disc recording device according to an embodiment of the present invention.

### DESCRIPTION OF THE EMBODIMENTS

In this embodiment, the 32× optical disc recording device is used as an example in the following, but the present invention is not limited thereto.

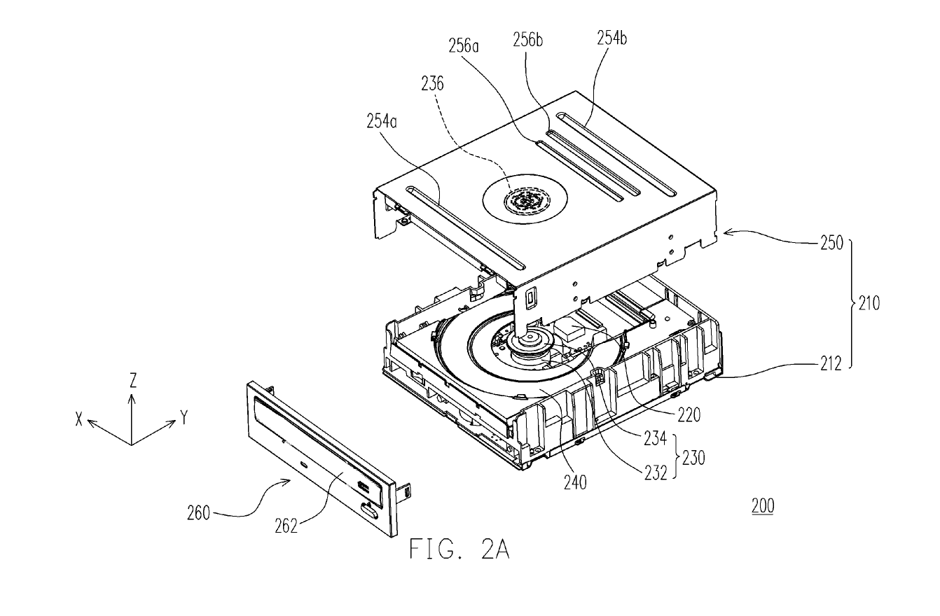

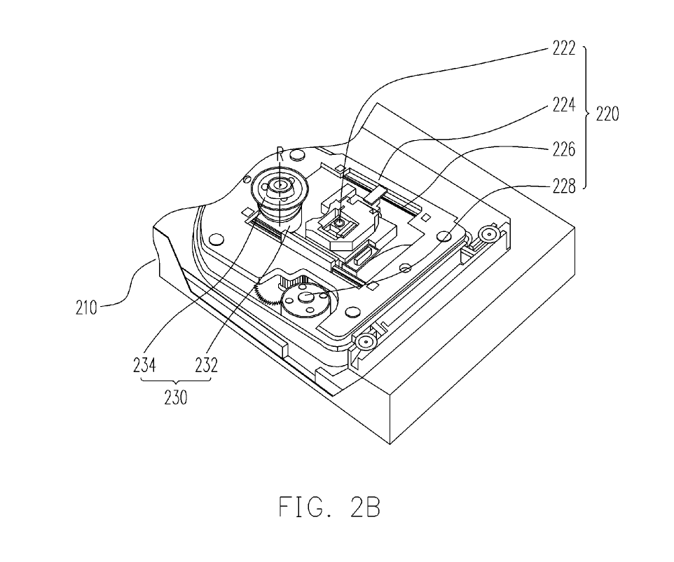

FIG. 2A is shows a schematic and exploded diagram of an optical disc recording device according to an embodiment of the present invention. And FIG. 2B schematically illustrates the structure of an optical write/read module and a transmission module of the optical disc recording device according to an embodiment of the invention. Please refer to FIG. 2A and FIG. 2B, the optical disc recording device 200 comprises a housing 210, an optical write/read module 220, and a transmission module 230. The housing 210 comprises a bottom housing 212 and a top cover 250. The optical write/read module 220 and the transmission module 230 are disposed inside the housing 210 respectively.

As mentioned, the optical disc recording device 200, for example, further comprises a front plate 260 connected to the top cover 250 and bottom housing 212. This front plate 260 usually comprises an insertion/rejection opening for loading or unloading the disc. In addition, the outer surface 254 of the top cover 250, for example, comprises structure-strengthening grooves 254a and 254b to increase the structure intensity of the top cover 250.

Please refer to FIG. 2A and FIG. 2B. The optical write/read module 220, for example, comprises an optical write/read head 222 to read the data from the optical disc. Besides, the optical write/read module 220 further comprises, for example, a fixed base 224 disposed inside the housing 210, a pair of lead rods 226 disposed over the fixed base 224. The optical write/read head 222 is disposed on a pair of lead rods and driven by the first motor 228 through the lead screw rod or gear assembly to move back and forth along the track-seeking path (i.e. Y-axis direction).

Referring to FIG. 2A and FIG. 2B, the transmission module, for example, comprises a second driving motor 232, a lower clamping piece 234, an upper clamping piece 236. The second driving motor 232 is disposed inside the housing 210 and connected to the lower clamping piece 234. The upper clamping piece 236 is disposed above the lower clamping piece 234, as shown in FIG. 2A. The lower clamping piece 234 together with the upper clamping piece 236 are adapted for clamping the optical disc. Next, the transmission module 230 is adapted for spinning the disc with respect to a rotation axis R. In addition, the lower clamping piece 234 together with the upper clamping piece 236, for example, clamp the disc by magnetism.

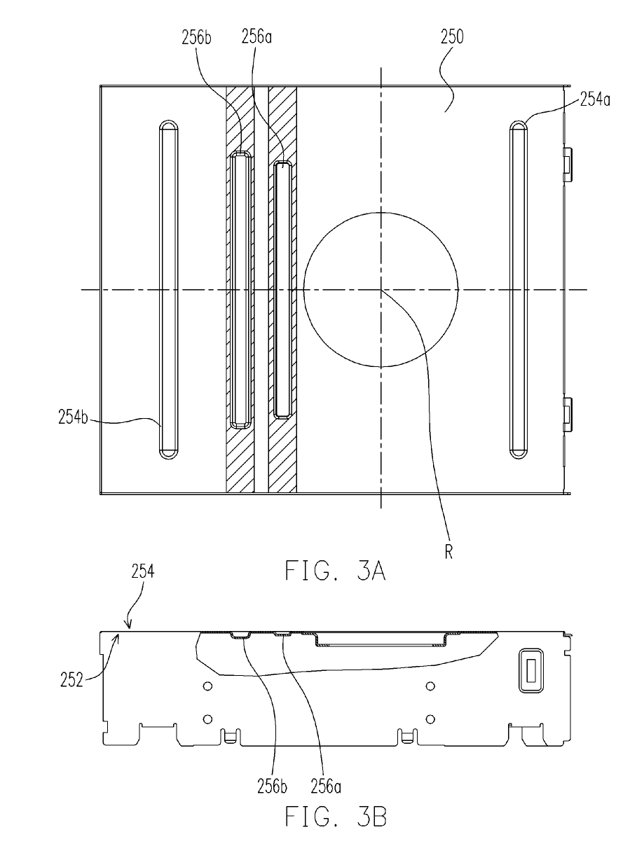

FIG. 3A schematically illustrates a top view of the top cover of an optical disc recording device according to an embodiment of the invention. FIG. 3B schematically illustrates a side view of the top cover of an optical disc recording device according to an embodiment of the invention. Please refer to FIG. 2A, FIG. 3A, and FIG. 3B. The inner surface 252 of the top cover 250 comprises a first protrusion 256a and a second protrusion 256b both disposed above the track-seeking path. The first protrusion 256a is closer to the rotation axis R than the second protruding 256b, but the height of the first protrusion 256a is lower than that of the second protrusion 256b.

Furthermore, the first protrusion 256a is disposed in an area 30 to 40 mm away from the rotation axis R, with a height range of about 0.8 to 1.2 mm. And the first protrusion 256a, for example, is one straight protrusion, which extends in a direction perpendicular to the track-seeking path. The second protrusion 256b is disposed in an area 45 to 55 mm away from the rotation axis R, with a height range of about 1.6 to 2.4 mm, and the second protrusion 256b, for example, is also one straight protrusion, which extends in a direction perpendicular to the track-seeking path.

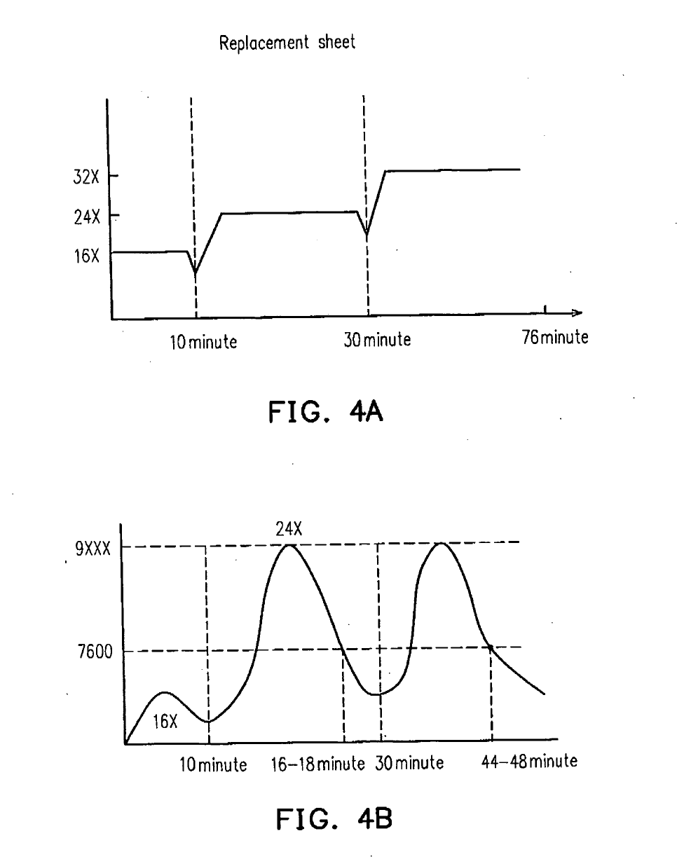

FIG. 4A illustrates a relationship chart between the writing speed versus location of the optical disc in the Z-CLV Mode optical disc recording device. Please refer to FIG. 4A. In general, the writing mode of the optical disc recording device 200 can be classified as Constant Linear Velocity Mode (CLV Mode), Constant Angular Velocity Mode (CAV Mode), Zone-Constant Linear Velocity Mode (Z-CLV Mode), Partial-Constant Angular Velocity Mode (P-CAV Mode), etc. Among various high-speed recording devices, the Z-CLV Mode is the most widely used, and thus the 32× speed, Z-CLV Mode optical disc recording device is taken as an example in the present embodiment.

FIG. 4B schematically illustrates a relationship chart between the rotation speed (RPM) versus location of the optical disc in the Z-CLV Mode optical disc recording device. Please refer to FIG. 4A and FIG. 4B. The conventional optical disc recording device 100 writes the data in the location about 44th to 48th minute of the optical disc (while rotation speed of the optical disc is around 7600 RPM). Due to an unstable flow field inside the optical disc recording device 100 caused by high-speed rotation of the optical disc, and coupling effect between the unstable flow field and the optical disc, the writing quality deteriorates, which results in failure in writing/accessing data in the location about the 44th to 48th minute of the optical disc.

According to the present invention, the inner surface 252 of the top cover 250 comprises a first protrusion 256a and a second protrusion 256b, which together can stabilize the flow field inside the optical disc recording device 200 during high-speed rotation of the optical disc, and the spinning of the optical disc can thus be stable.

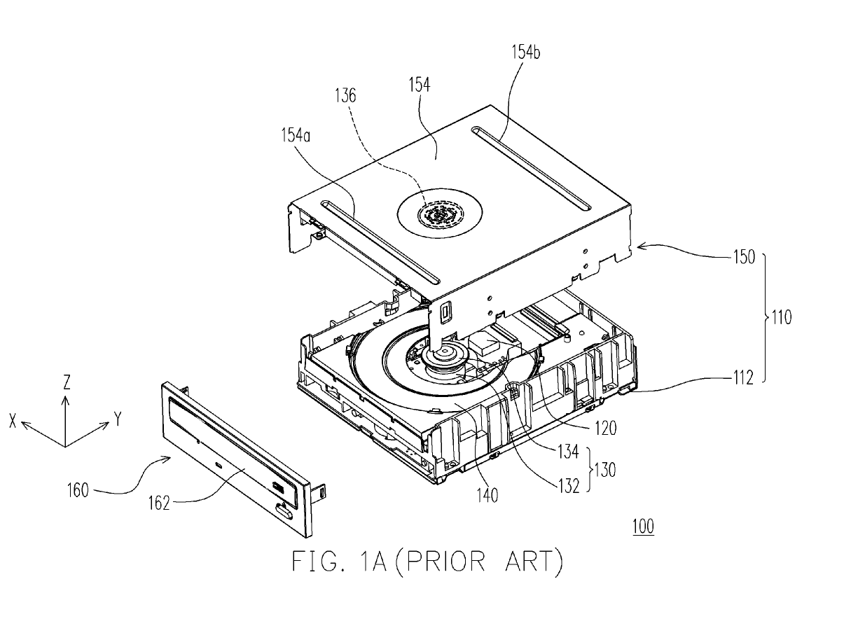

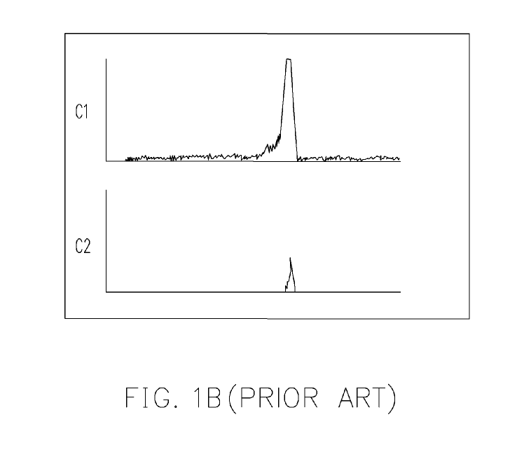

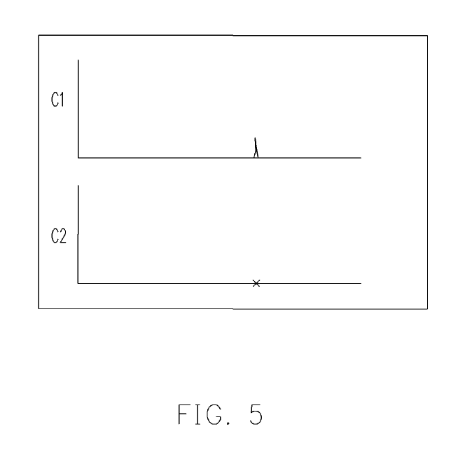

FIG. 5 shows measured results of the error rate C1 of decoding output of the RS-code in the first layer and the error rate C2 of decoding output of the RS-code in the second layer during a decoding operation in the 32× speed, Z-CLV Mode optical disc recording device according to an embodiment of the present invention. As shown in FIG. 5, the error rate C1 of decoding output of the RS code in the first layer apparently is decreased, compared with that in FIG. 1B. And the measured error rate C2 of decoding output of the RS-code in the second layer almost drops to zero.

Based on the measured results of error rate C1 of decoding output of the RS-code in the first layer and error rate C2 of decoding output of the RS-code in the second layer, it can be known that, by using the first protrusion 256a and a second protrusion 256b in the inner surface 252 of the top cover 250, not only can the flow field inside the optical disc recording device 200 be stabilized, but the writing quality of the optical disc recording device 200 can also be improved.

To sum up, the present invention has at least the following advantages.

1. In the optical disc recording device according to the present invention, the inner surface of the top cover has a first protrusion and a second protrusion which is able to stabilize the flow field inside the optical disc recording device, thereby improving the writing quality of the optical disc recording device.

2. In the optical disc recording device according to the present invention, the special design of the top cover can reduce the noise value by 0.6 dBA (Sound Pressure Level) compared with the conventional optical disc recording device.

3. In the optical disc recording device according to the present invention, the special design of the top cover can reduce 41% of the fluttering in the optical disc recording device compared with the conventional optical disc recording device.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An optical disc recording device, comprising:
a housing comprising a bottom hosing and a top cover;
an optical write/read module disposed inside the housing, wherein the optical write/read module comprises an optical write/read head which moves back and forth along a Track-seeking path; and
a transmission module disposed inside the housing, wherein the transmission module is suitable for spinning the optical disc rotation with respect to a rotation axis;
wherein, the top cover comprises an inner surface and an outer surface, and the inner surface of the top cover comprises a first protrusion and a second protrusion both disposed above a track-seeking path, the first protruding being closer to the rotation axis than the second protruding, and the height of the first protrusion being lower than that of the second protrusion.

2. The optical disc recording device according claim 1, wherein the first protrusion is one straight protrusion and its extended direction is perpendicular to the track-seeking path.

3. The optical disc recording device according claim 1, wherein the second protrusion is one straight protrusion and its extended direction is perpendicular to the track-seeking path.

4. The optical disc recording device according claim 1, wherein the first protrusion is disposed in an area 30 to 40 mm away from the rotation axis, with a height range of 0.8 to 1.2 mm.

5. The optical disc recording device according claim 1, wherein the second protrusion is disposed in an area 45 to 55 mm away from the rotation axis, with a height range of 1.6 to 2.4 mm.

6. The optical disc recording device according claim 1, wherein the optical write/read module further comprises:
a fixed base disposed inside the housing;
a pair of lead rods disposed over the fixed base, wherein the optical write/read head is disposed on the pair of lead rods to move back and forth along the track-seeking path; and
a first driving motor for driving the optical write/read head to move back and forth along the track-seeking path.

7. The optical disc recording device according claim 1, wherein the transmission module comprises:
a second driving motor disposed inside the housing;
a lower clamping piece connected to the second driving motor; and
an upper clamping piece disposed above the lower clamping piece, and the lower clamping piece together with the upper clamping piece are adapted for clamping the optical disc.

8. The optical disc recording device according claim 7, wherein the lower clamping piece together with the upper clamping piece clamp the disc by magnetism.

9. The optical disc recording device according claim 1, wherein the outer surface of the top cover further comprises at least one structure-strengthening groove.

10. The optical disc recording device according claim 1, further comprising a front plate connected to the top cover and the bottom housing, and the front plate comprises an insertion/rejection opening for loading or unloading an optical disc.
